(19) United States
(12) Patent Application Publication
(10) Pub. No.: US 2024/0223125 A1
(43) Pub. Date: Jul. 4, 2024

(54) POLYANGULAR, SPECULAR MINI-STRUCTURE FOR FOCUSED, SOLAR-ENERGY-SUPPLIED BATTERY

(71) Applicant: SOLMET LLC, New York, NY (US)

(72) Inventor: San Cheng, Mt. Laurel, NJ (US)

(21) Appl. No.: 18/604,463

(22) Filed: Mar. 13, 2024

Related U.S. Application Data
(63) Continuation-in-part of application No. 18/237,267, filed on Aug. 23, 2023.
(60) Provisional application No. 63/401,419, filed on Aug. 26, 2022.

(51) Int. Cl. H02S 40/22

(52) U.S. Cl. CPC H02S 40/22

(57) ABSTRACT

A polyangular, specular, mini-structure comprises a faceted, hollow sphere, with an aperture and focusing lens within such aperture permitting sunlight to enter the interior of such faceted sphere. The facets have inner surfaces which are specular such that light entering the sphere is reflected multiple times. One or more polyangular, specular mini-structures may be optically connected to an optical-to-electrical module, which module includes a plurality of light-responsive elements therein. The light transmitted from the polyangular, specular, mini-structure impinges upon the light-responsive elements, such as a polysilicon chip or wafer and a reflecting mirror, so as to generate electric potential suitable for powering devices, installations, and electric vehicles, in the manner of a battery.

### CROSS-REFERENCE TO RELATED APPLICATIONS

This application is a continuation-in-part of U.S. patent application Ser. No. 18/237,267, filed Aug. 23, 2023, currently pending, the entire contents of which are hereby incorporated by reference.

### FIELD

This disclosure relates to solar power generation and more particularly, to a polyangular specular mini-structure to supply electricity.

### BACKGROUND

The concept of capturing solar energy to produce electricity is known, and includes conventional photovoltaic systems. Current solar energy systems likewise may involve a focusing system known as concentrator photovoltaics (“CPV”), which uses lenses or other specular structures to focus sunlight onto small, highly efficient, multi-junction solar cells.

Such CPV systems likewise use computer programming to increase their efficiency. Such computer programming is generally linked to physical devices for tracking of the sun, referred to as solar trackers.

There has also been work on polyangular specular reflector designs for ultra-high spectrum splitting and resulting increases in solar module efficiencies (see, Polyhedral Specular Reflector Design for Ultra-High Spectrum Splitting Solar Module Efficiencies (50%), Eisler et al, SPIE, Calif. Institute of Technology, 2013.

These and still other solar power systems of the current art suffer from various drawbacks and disadvantages, including the need to manage thermal energy, and the drop of efficiency or operability outside of sunny days or outside of optimal conditions.

For example, the most suitable temperature for traditional solar panels and corresponding solar cells for energy conversion ranges between about twenty three to about twenty eight degrees Celsius. Outside of such suitable range, temperature conversion rates and other operating parameters decline steeply. In addition, solar cells and traditional solar panels are relatively expensive, made out of silicon carbide. Furthermore, optimal energy conversion from solar radiation is obtained primarily under direct sunlight and even under such circumstances, costs of conversion of direct sunlight to electrical energy is relatively high, making solar energy less sought after than other energy sources.

Lithium nickel manganese cobalt oxides are mixed metal oxides (often abbreviated LiNMC, LNMC, NMC, or NCM, hereinafter referred to as “NMC”). NMC batteries are found in many electric cars.

### SUMMARY

In certain versions of the present disclosure, a solar energy system makes use of one or more polyangular, specular, mini-structures. The disclosed mini-structure uses a hollow chamber in which reflective facets are disposed within, at angular orientations on the interior surface to define a light reflective interior of the chamber. To harness solar energy, the mini-structure has a light-receiving aperture and a light transmission aperture extending into and out of the mini-structure.

The angularly oriented, reflective facets are located to reflect light which enters the chamber at a first lux value, until the reflections generate a light output light having a second lux value greater than the first lux value. The light transmission aperture located and configured to permit the light output to exit therethrough.

An optical-to-electrical module is secured relative to the polyangular specular mini-structure to receive the light output and convert the light output into electricity. In certain versions, the optical-to-electrical module makes use of multiple light-responsive elements, such as a silicon surface and a reflecting mirror. The light-responsive elements are oriented to be impinged upon directly or indirectly by the light output received in optical-to-electrical module to generate an electric potential as a function of the light output. The solar energy system includes an electrical interface electrically connected to the optical-to-electrical module for receiving the electric potential and outputting current over time for at least one of electrical charging and storage.

In still other implementations, there are two pairs of silicon surfaces among the light-responsive elements, each of the silicon surfaces are located on respective ones of four inner walls of a cuboid compartment of the optical-to-electrical module.

According to some versions, the hollow chamber of the polyangular, specular mini-structure comprises a hollow sphere, the interior reflective facets of the polyangular specular mini-structure comprise 120 triangular facets, and the interior reflective facets comprise a reflective layer of aluminum.

In yet further implementations, polyangular specular mini-structures composed of any of the materials set forth in this disclosure, may be arranged and interconnected to form an array of such mini-structures, affixed to a panel, and thereby either form a battery or supplement a battery for an electric vehicle.

In still further implementations, arrays and associated panels of the polyangular specular mini-structures disclosed herein may be configured to power portable electronic devices, such as smart glasses, smartphones, drones, and residential homes.

The foregoing summary and this disclosure will be better understood with reference to the drawings, in which:

### BRIEF DESCRIPTION OF DRAWINGS

FIG. 1A and FIG. 1B are perspective and side sectional views, respectively, of a power mini-structure in the form of a polyangular, specular faceted sphere;

FIG. 2A and FIG. 2B are exploded and schematic views of a focusing lens group suitable for an aperture formed in the faceted sphere shown in FIG. 1;

FIG. 3 is an isometric view of an array of polyangular specular mini-structures for use as a battery or in conjunction with a battery of an electric vehicle;

FIG. 4 are perspective schematic views of still further applications of polyangular specular mini-structures according to the present disclosure;

FIG. 5 is a partly schematic view of an embodiment of the polyangular specular mini-structure according to the present disclosure, in a test environment;

FIG. 6 is a cross-sectional view of an embodiment of the polyangular specular mini-structure, according to the disclosure herein;

FIG. 7 is an enlarged sectional view of the cross-section of FIG. 6;

FIG. 8 is an isometric view of further implementations according to the present disclosure;

FIG. 9 is an elevational, cross-sectional view of the implementations of FIG. 8; and

FIG. 10 is an isometric view of still further implementations of the present disclosure.

### DETAILED DESCRIPTION

In one implementation, with the foregoing background in mind, an improved solar energy system, which is the subject of this disclosure, comprises multiple, polyangular specular mini-structures to produce focused solar energy for use in batteries for devices, such as electric vehicle batteries.

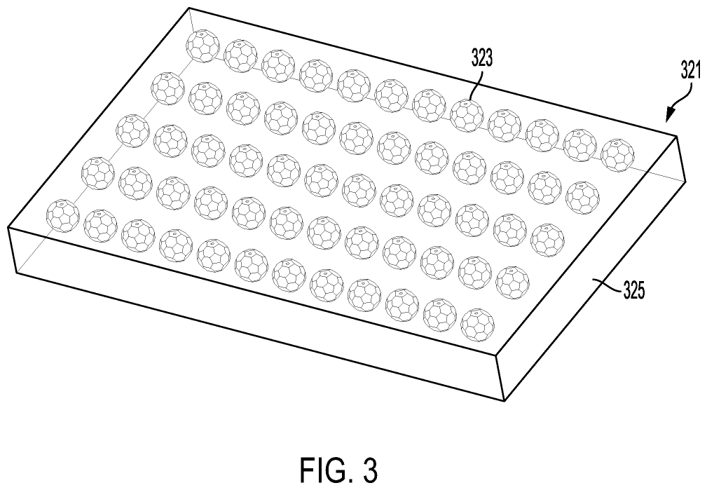

As such, a solar-energy-powered battery 321 as shown in FIG. 3 comprises an array of polyangular specular mini-structures 323, also known as crystal-like pearls, light-fusion or light-focusing crystals, photon energy spheres, or PES (singular or plural). The multiple polyangular specular mini-structures 323 arranged on a panel 325 focus solar energy by virtue of their configuration shown in FIG. 3. In one preferred implementation, the panel 325 is a square of about ten inches (10″), and has one hundred (100) light fusion crystals configured to reflect or refract light in different ways, whether from direct sunlight, overcast or diffuse sunlight, or light sources after sunset.

The plurality of light fusion crystals or light focusing crystals absorb solar energy and convert such energy to heat, but more importantly, to an electric potential arising from ionization of NMC or other material capable of ionization. This electric potential is linked to the power system of the device or system requiring power, such as for electric vehicle, either as a stand-alone NMC battery or supplement thereto.

The panel 325 shown and described herein can also be used wherever current solar energy uses, and like installations, are found, such as for home use, within companies, factories, government facilities, military. The panel can likewise be used as a battery for buses to travel unlimitedly.

In one possible implementation, shown schematically in FIG. 3, 100 light fusion crystals are in the 10-inch panel, 15 are direct ray of intense light emitted from the sun, 35 are light import from rainy days or cloud transmission, 50 low light imports from the night light source. The lens orientation of the fusion crystals may be controlled by suitable software. Elements are used within the panel to absorb light energy, heat energy and electrical energy. The three energy sources may be introduced into hydrogen energy batteries to store electricity.

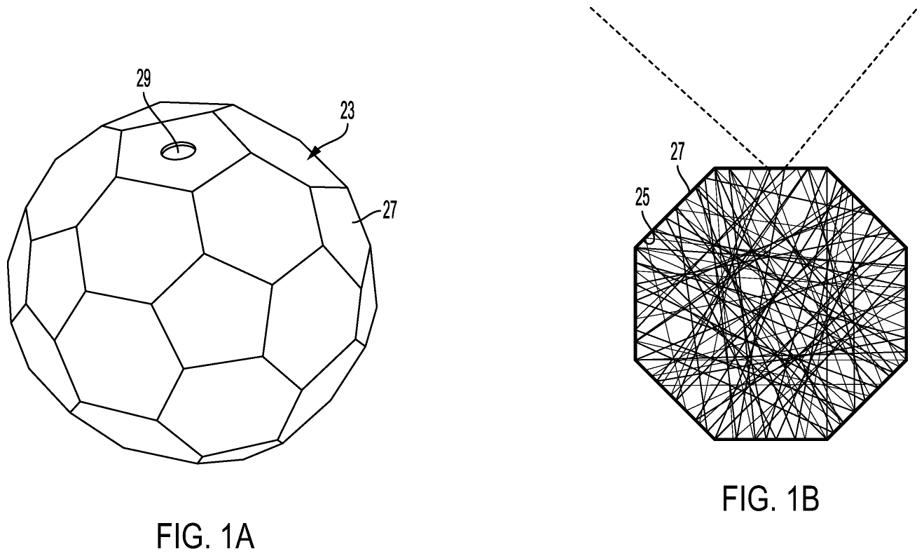

Referring now to FIGS. 1A and 1B, according to one suitable implementation, polyangular specular mini-structures 23 are hollow, having inner and outer surfaces 25, 27, and an aperture 29 through which solar light enters the inside. In one preferred arrangement, the mini-structure is in the form of a faceted sphere and has a diameter of 3.6 cm and 360 hexagons forming the facets. The preferred diameters of individual spheres may range from 6 mm to 80 mm. In one implementation, the outer surface of the faceted spheres comprises nickel or NMC, whereas the inner surfaces are reflective. The walls of the structures/spheres may comprise glass or other carrier material, either of which is treated or coated with NMC. The specular structures are preferably spheres faceted with hexagonal structures, the interior being hollow and the interior surfaces of the hexagons being mirrored, specular, or otherwise reflective.

Opening 29 permits solar light to enter the interior of specular mini-structure 23, where it is reflected countless times. The reflective faceted inner surface 25 generates heat or ionizing radiation with regard to its constituent material, such as the NMC material. The reflected solar radiation produces a corresponding electric potential to form a battery to power the associated device or written installation. Based on early tested digital results with a heat measuring instrument, energy output exceeded the instruments maximum limit of 500 KW. Accordingly, in further testing, 100 MW is a very conservative estimate and is not the final result as well.

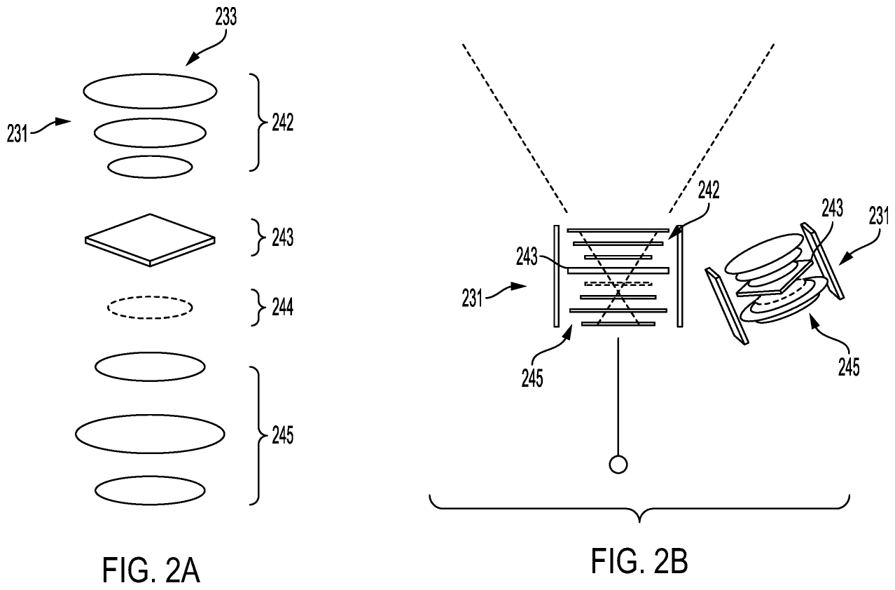

The solar light, in turn, is focused by a series of lenses 231 shown in FIGS. 2A and 2B, and constituting a focusing mirror group design 233. Such mirror group design 233 preferably comprises an object lens group 242, a prism group 243, a focusing lens/mirror 244, and an eye piece group 245.

The particular optics of the focusing mirror group design 233 have been suitably made with the following characteristics: All are the same size outer circumference with different thicknesses, arranged as shown in FIGS. 2A and 2B, according to the size of each of the specular mini-structures 23, 323 from the panel 325 in FIG. 3, as follows:
1) 2.5 mm*16 mm,
2) 1.6 mm*16 mm,
3) 4.5 mm*16 mm,
4) 3.0 mm*16 mm

The dimensions adjust according to the proportions of mini-structure 23.

The polyangular specular mini-structure 23 disclosed herein has been found suitable with the following characteristics relating to its interior surface structure, faceted sides, and overall dimensions as follows: each pearl: 3.6 cm*3.6 cm, with 360 hexagons.

The panel 325 for use in connection with an electric vehicle battery shown in FIG. 3 generates an electric potential by interfacing the array of specular structures to the NMC battery or to serve as a replacement for the traditional battery.

In another implementation, a polyangular specular mini-structure has facets composed of one or more of the following materials: quartz, silica sand, tungsten trioxide, silicon carbide, single-crystal silicon, and silicon dioxide. In certain implementations, the facets have a sufficient amount of the tungsten trioxide such that, when they are subject to a stimulation current, ion emission occurs. The composition and amount of tungsten trioxide are selected so that, in response to the stimulation current, the ion emissions are reflected within the mini-structure sufficiently to first charge the mini-structure up to an electric generation threshold, and, thereafter, upon reaching such electric generation threshold, to transmit light for reflection within or through the mini-structure until the ion emission falls below the electric generation threshold. The transmission of light, or reflection of light beams, in turn, reacts with the facets and materials from which the facets are composed, so as to generate a supply of electricity at greater amp-hours than the stimulation current.

In still another potential implementation, computer programming, whether adaptive programming or artificial intelligence-related generative instructions, are operatively associated with the foregoing operations of the polyangular specular mini-structure, so as to control the stimulation current in terms of timing, amount, and duration, in response to the generation of the supply electricity.

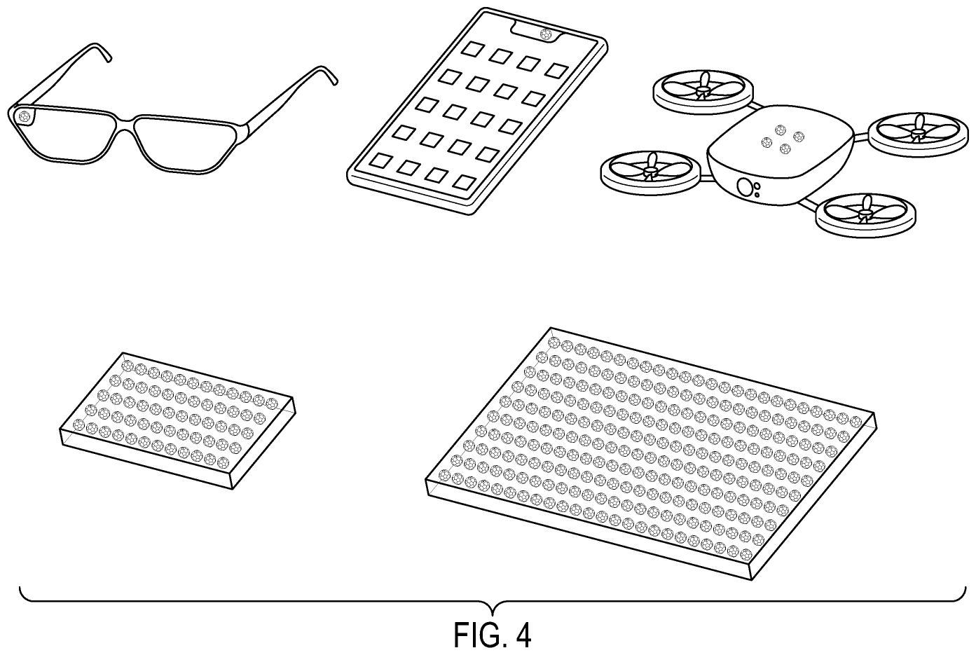

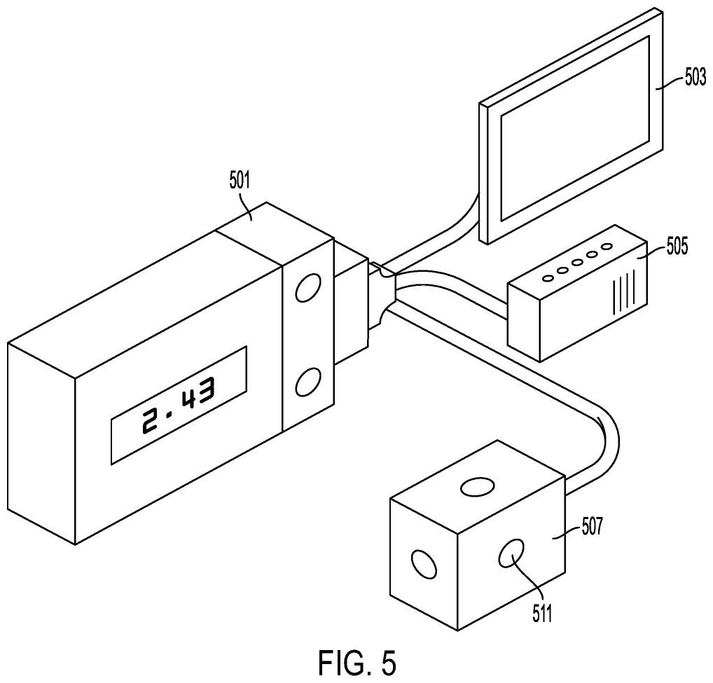

The polyangular specular structure 23 may find application as a power source, such as a battery, in any number of devices, including consumer electronics devices shown in FIG. 4.

The principle of operation of such power source is apparent to one of skill in the art from the foregoing description. The polyangular specular structure 23 (again, also referred to as a photon energy sphere or PES), compresses strong beams of light of over 0.5 mm through mirror group 233, which are reflected hundreds of millions of times per second in the 360-facet implementation of mini-structure 23. Together with silicon carbide, monocrystalline silicon, and silicon dioxide, the strong beams and silicon structure will form an electron vortex. The strong beams and electron vortices generate electricity through a suitable optical-to-electrical module, which is charged into various batteries through an inverter unit that converts direct current and alternating current.

The 360 hexagonal-cut PES glass spheres (mini-structures 23) have been formed in different sizes and have been passed through a suitable electric wattage power test apparatus, such as that in FIG. 5, with the current test results as follows:

Each 6 mm sphere can generate 10 KW of electricity in one second, which can be used for a variety of electronic products such as smartphones, tablets, laptops, smart glasses and so on.

Each 1.2 cm sphere can generate 25 KW of electricity in one second, which can be used for electric locomotives, electric scooters, lightweight drones, and a variety of smart home appliances.

Each 3 cm sphere can generate 100 KW of electricity in one second, which can be used for electric vehicles, eVTOL (Electric Vertical Take-off and Landing), air cabs, intelligent street lights, UAV, various military laser weapons, satellites, airbase stations, and various means of transportation.

Each 6 cm sphere can generate 300 kW of electricity in one second, which can be used for apartments, office buildings, manufacturing plants, shopping centers, desalination plants, various ships, all government facilities, all military bases, and so on.

According to the current experimental results, glass spheres with 360 hexagonal cuts are the most energetic, and spheres with 60 or 120 hexagonal cuts also work well and produce relatively less energy. Combinations that also work well are glass spheres made of 60 or 120 or 360 pentagonal cuts, glass spheres made of 60 or 120 or 360 mixed pentagonal and hexagonal cuts, and glass spheres made of 60 or 120 or 360 triangular cuts, which also produce relatively less energy. The entirety of the sphere without cuts or with still fewer cuts may likewise generate electricity at a very low efficiency.

The foregoing wattage generations are associated with tests using an electric wattage power test apparatus, such as that shown schematically in FIG. 5. An electric wattage power test meter, such as that made by MOLECTRON, in the form of a laser power meter 501, is interconnected with a suitably programmed computer 503, such as a tablet, running adaptive programming for electronic and wattage control, and a ternary polymer lithium battery 505. One significant aspect of the testing apparatus and corresponding results relate to an optoelectronic module 507 in which a 6 mm-diameter PES 511 is substantially contained. PES 511 may comprise facets and be formed of any of the combinations of materials disclosed herein when manufactured by the 3D printer mode set out herein. The optoelectronic module 507 allows PES 511 to receive incoming light, such as solar light, at an amount, such as in amp-hours, to provide a stimulation current to PES 511.

In response to said stimulation current, PES 511 generates supply electricity which is shown in the laser power meter as 2.43 kw for a duration of 0.5 seconds. The supply electricity, in turn may charge ternary polymer lithium battery 505.

With regard to the arrays or panels 325 of multiple PES structures, such as those shown in FIGS. 3 and 4, a 9×9 cm panel has AI programming, and is made up of nine 3 cm spheres. Such dimensions may be will be used in electric vehicles (with a panel size smaller than two iPhones), of which three spheres are mainly responsible for capturing the sun's direct light sources, which can be instantly charged into all batteries, another three spheres are responsible for capturing weak light sources such as sunset or rainy light, and the remaining three spheres are responsible for capturing the continuous source of light. A continuous source of light may be a relatively small light source, as compared to solar light, such as street lamps at night, various signboards or store light source. This light source, while weak light or shimmering light, may maintain or stimulate the PES sphere, and can thus become a permanent energy source without the need to dedicate further light. If the continuous source of light is captured successfully, it can be used for time ranging from a few months to a year. Similarly, different arrangements and combinations of PES structures may be devised according to different environments to meet power needs.

Each PES has an independent light measurement sensor and AI chip, allowing it to constantly adjust the direction of capturing the light source during operation. Even in environments with no light source at all, small LED light-emitting devices may serve as sources for the PES, so that the PES is capable of charging.

At present, there are three workable modes of manufacture of the PES structures or glass spheres (mini-structures 23).

In one possible implementation, the following steps are performed using suitable materials processing techniques and related equipment for such processing: Melt quartz, silica sand and tungsten trioxide into glass glue liquor, and add silicon carbide, single crystal sand and silicon dioxide into the liquid. Use a precision industrial 3D printer to transform the glass glue liquor into transparent sphere layer by layer. In one suitable implementation, recycled glass was found suitable as a raw material for use with the disclosed 3D printing process.

Finally, glue or other suitable adhesive may be used to affix the miniature mirror group above the sphere.

It is expected, from certain tests and related calculations, that by stimulating tungsten trioxide with 4 ah (amp-hours) of electricity, the entire transparent glass sphere will turn into an ionic mirror. Light exits the PES and passes through the mirror group to produce a polar beam, which is reflected billions of times in the mirror sphere. So the sphere is generally completely transparent. When electricity is required, the PES comes into a completely mirror-like state in response to re-stimulation of the tungsten trioxide at a suitable stimulation current, such as 4 amp-hours. Again, when the PES is fully charged and is about to discharge, it will return to the glass state, and all beams of light will leak through transparent glass. A specially designed AI chipset controls the electric current and electronic stimulation associated with this iterative process.

Another suitable method of manufacture involves metallurgical mold processes such as those making use of a unibody mold opening. Firstly, stainless steel is used to open an inner mold and an outer mold. The inner mold is polyhedral stainless steel ranging from 30 to 720 facets, and the outer mold is spherical stainless steel. For the proposing mold surfaces, whether faceted or not, it is preferable for the surfaces to have similar areas to promote refraction. The thickness of the inner and outer molds is 2 mm, and a hole with a diameter of 5 mm is left above. Soda ash, limestone and quartz are melted at respective melting points to form a glass glue liquor at a high temperature of 1,600° C., and the liquor is poured through the 5 mm hole. Then, rotary heat is applied to 600° C. for molding. After water cooling and gas cooling, the mold is opened to remove the glass sphere from the mold. Silicon carbide, monocrystalline silicon, silicon dioxide are sprayed into the 5 mm hole to form a coating within the molded, faceted sphere. The miniature mirror group is placed operatively adjacent to the 5 mm hole. A further 1.2 mm aperture is formed in the PES sphere, such as at a location opposite the 5 mm hole.

In operation, the aperture is then controlled with a motor aperture for cameras, and the surrounding area is covered with graphene. An AI chip is used to control the current and drive electricity generation operations of the sphere. It is possible to control the direction of the sphere after it is fully charged, and turn the aperture to a position where there is no grapheme, thereby draining all beams of light out, and thereafter returning the sphere to its limited position before such turning.

In still another possible implementation, the molding processes involve a hemi mold-opening. The design of the sphere is divided into two hemispherical molds, with the top mold being a polyhedral stainless steel mold and the bottom being a spherical stainless steel mold. The associated steps comprise the following: Quartz sand and quartz are melted into glass glue liquor at a high temperature of 1,600 degrees, which is poured into the bottom mold pressed by the top mold. Thereafter, it is possible to rapidly mold the molded hemispherical modules with cooling gas. Impurities are removed with UV and then the molded output is polished with ammonia. The resultant molded, faceted components are treated to form a coating with silicon carbide, monocrystalline silicon and silicon dioxide. A laser is used to stitch the two hemispheres together with glass liquor or grapheme to form a complete sphere. It is then possible to coat the outside of the sphere with silver nitrate and silver sulfide to form a mirrored sphere. A 1.2 mm transparent glass port is left to form an aperture for use in electricity generation operations.

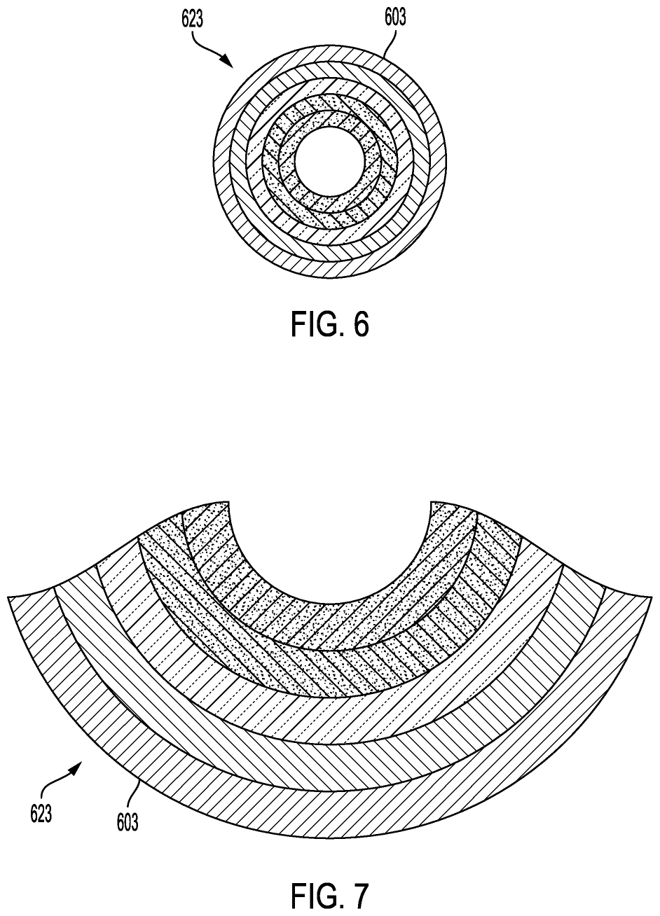

Referring to FIGS. 6 and 7, in one suitable implementation of a PES and the foregoing manufacturing process set forth immediately above, it is expected that concentric layers may be formed in PES 623, and provided with corresponding facets 603, with the innermost layer comprising a mixture of silicon carbide and single crystal silicon having a thickness of 0.18 mm, and with successive overlying layers comprising silicon dioxide having a thickness of 0.22 mm, a mixture of quartz and quartz sand to form a glass layer having a thickness of 2 mm, silver nitrate having a thickness of 0.5 mm, and silver sulfide having a thickness of 0.8 mm. Thereafter a miniature mirror group such as that shown in FIGS. 2A and 2B, may be placed in operative proximity to the above-described faceted sphere. An AI chip may completely guide the current control and light emanations from PES 623.

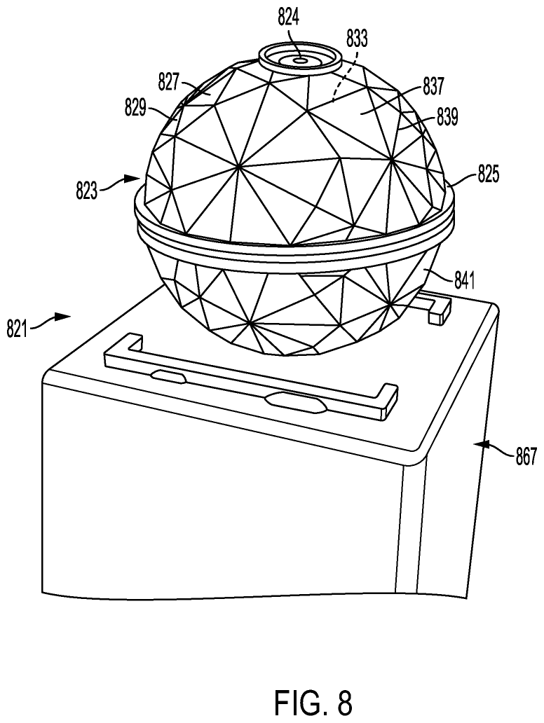

Referring now to FIGS. 8-10, in further implementations of this disclosure, a solar energy system 821 makes use of a polyangular specular mini-structure 823 configured with an outer layer 827 having an outer surface 829 formed into a hollow spheroid, in this case, a sphere 825. Outer layer 827 in certain implementations is formed of polymeric material, rather than glass, such polymeric materials as polymethyl methacrylate or PMMA. Sphere 825 may be formed by any suitable molding process, in this case, two hemispherical molds.

Outer layer 827 may be formed of translucent or transparent material, as in the illustrated embodiment, thereby making visible a second layer 833 of the mini-structure 823. Outer layer 827 substantially surrounds, encloses or encapsulates second layer 833. Second layer 833 has opposite inner and outer surfaces 831, 835.

Second layer 833 has a pattern or array of facets 837 formed therein or thereon, facets 837 being oriented at interior angles to each other, meaning angles at less than 180 degrees measured from the interior. As such, facets 837 face interiorly into a hollow chamber 845 defined within sphere 825. Facets 837 are light reflective and are formed of aluminum in this implementation, such aluminum potentially finished or otherwise formulated to have reflective properties when formed into facets 837. The aluminum may be applied as a stiff metallic element, a foil, or as particulate, paint, liquid, or any other suitable solution, and by any suitable means of application, such as by adhesion or bonding when solid or foil, or by painting, spraying, sputtering, vapor deposition, and the like, in the event of particles or liquid.

In one possible implementation, inner surface 828 of outer layer 827 may itself be faceted into a predetermined array or pattern, and second layer 833 comprises a thin layer of aluminum applied to or otherwise formed on the faceted inner surface 828 of outer layer 827, thereby forming the interiorly oriented array of facets 837 for the polyangular specular mini-structure 823 on inner surface 831 of second layer 833.

As in the previous embodiments of FIGS. 1-7, facets 837 may assume any number of interiorly oriented and angled configurations, may be formed in any shape, size, or quantity; with surfaces that may be either planar, arcuate, or both; and having simple or complex geometries. Facets 837, in whatever shape or size, may extend partially or completely over the inner surface 831 of second layer 833.

Polyangular specular mini-structure 823 has a light receiving aperture 824 formed on an upper surface 839 orientable toward the sky, toward ambient light, or toward an overhead light source. At another location on mini-structure 823, such as diametrically opposite, another aperture, that is, a light transmission aperture 826, is located on a lower surface 841 extending opposite upper surface 839.

In the illustrated implementation of FIGS. 8-10, there is an array of 120 triangular-shaped facets 837 disposed adjacent each other, and meeting at angular orientations with respect to each other at opposing common sides, thereby forming a reflective pattern of facets 837. The pattern follows and extends over the entire inner surface 831 (except for apertures 824 and 826).

Polyangular specular mini-structure 823 optionally includes a third layer 843 secured interiorly to second layer 833 and partially or fully coextensive therewith. Third layer 843 is formed of silicon dioxide with suitable light-reflective and light-responsive characteristics.

Reflective facets 837 thus define a light reflective interior for hollow chamber 845, with each of the apertures 824, 826 in optical communication with such interior. More specifically, receiving aperture 824 receives light therethrough, such light having a corresponding energy over time. Light received into chamber 845 thus has a corresponding lux value. Angularly oriented, reflective facets 837 are located to reflect such light sufficiently to generate a light output with a second lux value greater than the first lux value.

Solar energy system 821 makes use of an optical-to-electrical module 847 secured relative to mini-structure 823 so as to receive the light output and convert it into electricity. To accomplish this, optical-to-electric module makes use of multiple light-responsive elements 849 secured and oriented within a compartment 851. Compartment 851 has one or more walls extending in any configuration suitable for light-responsive elements 849 to act upon or function in response to the light output.

In the illustrated implementations of FIGS. 8-10, compartment 851 has four walls oriented rectilinearly to define inner sidewalls 853 of a cuboid. Compartment 851 may be substantially fully enclosed by opposite top and bottom walls 855, 857, except for compartment aperture 859 defined in and extending through top wall 855. The light output exiting light transmission aperture 826 of mini-structure 823 is received into compartment 852 through compartment aperture 859.

In the illustrated implementation, Light-responsive elements 849, which are acted upon or reacting to light received into compartment 851, include two pairs of silicon surfaces 863, each silicon surface 863 secured to one of the inner sidewalls 853. A first reflecting mirror 865 is located on an inner surface 861 of bottom wall 857, centrally between silicon surfaces 863, and a second such reflecting mirror 865 may optionally be located on the inner surface of top wall 855. One or both of reflecting mirrors 865 may be in the form of an arcuate, light collecting mirror and may be sized to extend substantially to the edges of corresponding top wall 855 or bottom wall 857 so as to terminate proximate to, adjacent to, or coincidental with inner sidewalls 853.

Silicon surfaces 863 may comprise any of a variety of photovoltaic or otherwise photo-reactive silicon compounds, such as a polysilicon photovoltaic solar cell or wafer, single crystalline chips or wafers, or electronic grade wafers or chips. In one suitable implementation, sidewalls 853 are sized to receive 16 cm×16 cm polysilicon wafers to occupy at least half of the area of sidewalls 853.

The configurations and dimensions of optical-to-electrical module 847, light responsive elements 849, and compartment 851 may be varied to suit the lux and other electrical performance requirements sought by the application for the solar energy system 823. Some variations would encompass using a non-cuboid version of compartment 851, whether with a lesser or greater number of sides, such as to have sidewalls 853 arranged in a triangular, pentagonal, or hexagonal transverse cross-section, or having a single, cylindrical one of sidewalls 853 so as to form a circular cross section, or having compartment 852 be spheroid.

Similarly, returning to the illustrated cuboid embodiment of compartment 851, a single pair of silicon surfaces 863 may be secured on a corresponding, opposing pair of inner sidewalls 853, with reflecting mirror 865 disposed between the two opposing silicon surfaces and oriented to reflect the light output toward the silicon surfaces 863. In still further variations, compartment 851 includes a single silicon surface 863 and a single reflecting mirror 865, each such light-responsive element oriented to be impinged upon, either directly or indirectly, by the light output received in optical-to-electrical module 847.

Regardless of the configuration of light responsive elements, light output received in compartment 851 and acting upon light responsive elements is sufficient to generate an electrical potential. Such electrical potential is a function of one or more of the optical components discussed herein, as well as the intensity of the light output itself and the extent of reflection or impingement of such light output on light responsive elements.

Compartment 851, in the illustrated embodiment, is located within a base 867. As such, solar energy system 821 has an upper surface 869 orientable toward the sky or other light source, and a lower surface 871 opposite the upper surface 869. Furthermore, as illustrated, light receiving aperture 824 is defined in such upper surface 869 and light transmission aperture 826 is defined in lower surface 871. Compartment aperture 859 is defined on and extends through upper surface 869 of base 867 because top wall 855 of compartment 851 and the upper surface of base 867 Arco are co-extensive. As such, polyangular specular mini-structure 823 is optically connected to optical-to-electrical module 847.

Solar energy system 821 includes an electrical interface 875 electrically connected to the optical-to electrical-module 847. Electrical interface 875 is adapted to receive the electric potential from light-responsive elements 849, and output such potential as current over time, kWhours, or any other power or suitable electricity measurements. The electric output may be used in any number of applications, depending on the scale of solar energy system 821, as discussed above or with reference to FIG. 4, including, for example, use in electrical charging or storage for consumer devices or electric vehicles.

In the illustrated embodiment, electrical interface 875 is located in base 867, such as relatively below compartment 851 when solar energy system 821 is operatively oriented toward a light source.

Solar energy system 821, polyangular specular mini-structure 823, optical-to-electrical module 847, light-responsive elements 849 and other components may be sized, scaled, oriented, and otherwise configured to generate power for any number of applications making use of batteries or use of grid or generated power, ranging from small appliances to a larger power systems. In one suitable example, electrical interface outputs 5 volts per second. In other implementations, interior reflective facets 837, when exposed by the light receiving aperture to 120,000 lux have been found to generate 170,000 lux as the light output received into optical-to-electrical module 847 for further power generation subsequent thereto. A suitable diameter for the polyangular specular mini-structures 823 achieving the foregoing results has been determined to be 6 cm, with the 120 facets 837 discussed above.

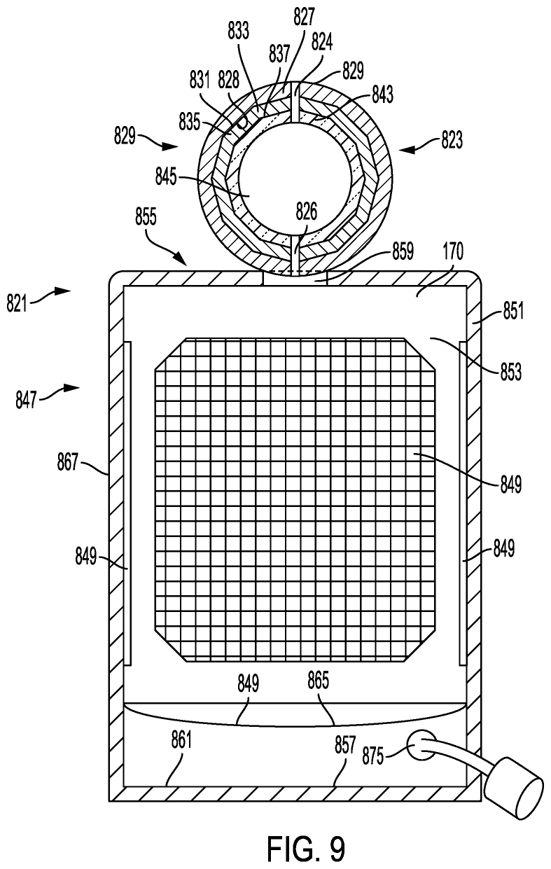

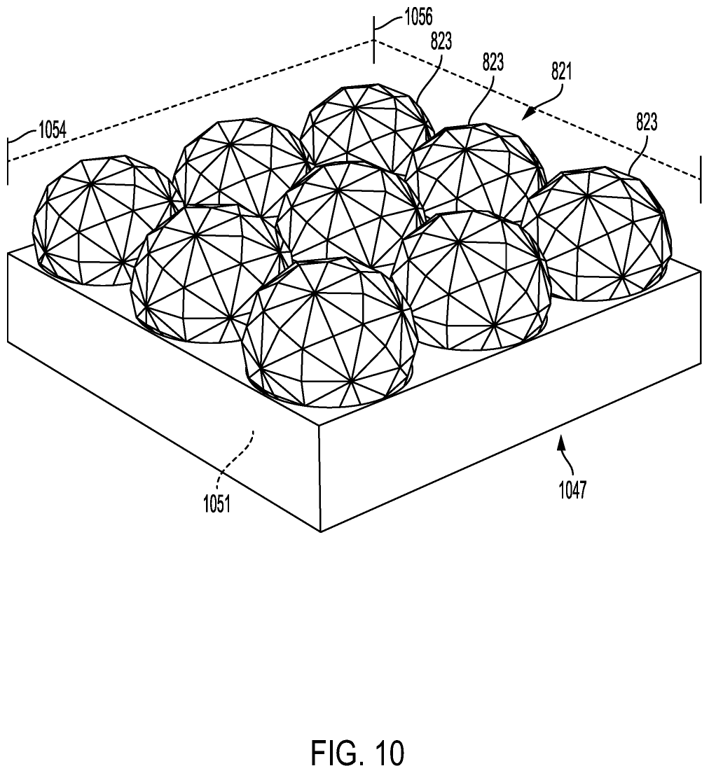

Among the different variations of components of solar energy system 821, as illustrated in FIG. 10, at least eight of the polyangular specular mini-structures 823, here shown as nine structures 823, each of 6 cm diameter, may be arranged in parallel to receive light in respective light-receiving apertures 824 and generate respective light outputs, all of which are transmitted to a compartment 1051. Compartment 1051 includes a plurality of light-responsive elements (such as those shown in FIGS. 8-9) and generates electrical potential and output power, as previously described with reference to FIGS. 8-9. In this embodiment, polyangular specular mini structures 823 are arranged to define a first, outer perimeter (shown schematically at 1054), and optical-to-electrical module 1047 in which compartment 1051 is located, is removably secured and optically connected to the plurality of polyangular specular mini-structures 823.

Module 1047 has module sidewalls located to define a second outer perimeter (shown schematically at 1056) greater than first outer perimeter 1054 of the array of mini-structures 823. Compartment 1051 is configured so that respective light outputs from each of the mini-structures 823 impinge upon the light-responsive elements 823 within compartment 1051.

Still further arrays of polyangular specular mini-structures 823 may be operatively connected to one or more optical-to-electrical modules, either in different numbers or in different configurations, such as those illustrated in FIGS. 3 and 4.

Polyangular specular mini-structures 823 may include focusing lenses 877 located within, adjacent to, or otherwise in operative proximity to light receiving or transmission apertures 824, 826, so as to contribute to light output from the above-described reflective facets. Similarly, such lenses may be optically associated with optical-to-electrical module 847 to contribute to conversion of light output received in compartment 851.

Operation and associated methods of generating solar power are apparent from the foregoing description of solar energy system 821. One suitable method of generating solar power involves reflecting a received light beam having a first lux value against at least 120 specular, angular facets or surfaces. The facets or surfaces may be shielded from ambient light other than the light beam by taking the step of enclosing such surfaces in a palm sized chamber, thereby generating a light output having a second lux value greater than the first lux value.

The method further involves directing such light output in the form of a light transmission from the enclosed chamber, so as to impinge directly and indirectly upon a reflecting mirror and at least one polysilicon, photovoltaic surface, thereby generating an electric potential. The electric potential can then be outputted as current overtime, watt-hours, or any other suitably measurable unit of power or energy, to generate the solar power.

Solar energy systems 821 according to this disclosure are able to receive light through light receiving aperture from the sun, whether in cloudless or cloudy skies, as ambient sunlight in a sunlit room, from overhead artificial light, or from point light sources. In one implementation, solar energy system 821 has been suitably configured to generate electric potential from one or more beams of artificial light generated by LED point lights.

The advantages of the foregoing power mini-structure and related systems and applications are apparent from the foregoing description. In general terms, the light entering the specular, faceted spheres creates energy which can be maintained and thus become a sustainable energy source, substantially unaffected by temperature and climate. The sun's daylight hours likewise do not degrade the performance of the specular, faceted spheres having received light therein and the economics of the electrical energy created thereby have minimal conversion losses, unlike traditional solar cells, and therefore maintain conversion ratios at or closer to one hundred percent in the disclosed embodiments. Furthermore, unlike the silicon carbide of solar cells, the faceted, NMC mini-structures are relatively small and inexpensive.

What is claimed is:

1. A solar energy system, comprising:
a polyangular, specular, mini-structure in the form of a hollow chamber with an exterior surface and an interior surface, the interior surface having reflective facets disposed at angular orientations on the interior surface to define a light reflective interior of the chamber, the mini-structure having a light-receiving aperture and a light transmission aperture extending between the exterior and interior surfaces at respective locations on the mini-structure, each of the apertures being in optical communication with the interior of the chamber;
wherein the angularly oriented, reflective facets are located to reflect light having a first lux value when impinged upon by the light entering through the light receiving aperture sufficiently and to thereby generate a light output light having a second lux value greater than the first lux value, the light transmission aperture located and configured to permit the light output to exit therethrough;
an optical-to-electrical module secured relative to the polyangular specular mini-structure to receive the light output and convert the light output into electricity, wherein the optical-to-electrical module comprises light-responsive elements, the light responsive elements including at least one silicon surface and at least one reflecting mirror, the silicon surface and the reflecting mirror oriented to be impinged upon directly or indirectly by the light output received in optical-to-electrical module to generate an electric potential as a function of the light output;
an electrical interface electrically connected to the optical-to-electrical module for receiving the electric potential and outputting current over time for at least one of electrical charging and storage.

2. The system of claim 1, wherein the silicon surface comprises a polysilicon photovoltaic wafer.

3. The system of claim 1, wherein the silicon surface comprises electronic grade silicon in the form of one of a wafer and a chip.

4. The system of claim 1, wherein the light-responsive elements comprise at least a pair of the silicon surfaces extending in a spaced, opposing relationship, and wherein the reflecting mirror is disposed between the opposing silicon surfaces and oriented to reflect the light output toward the silicon surfaces.

5. The system of claim 4, wherein the light-responsive elements comprise two pairs of the silicon surfaces and wherein the reflecting mirror is disposed centrally between the two pairs of the silicon surfaces.

6. The system of claim 5, wherein the optical-electrical module comprises four inner walls and wherein each of the silicon surfaces are located on respective ones of the inner walls.

7. The system of claim 6,
wherein the four walls are oriented rectilinearly to define inner sidewalls of a cuboid compartment;
wherein the compartment has opposite top and bottom walls, the top wall having a compartment aperture therethrough;
wherein the light output from the polyangular specular min-structure is received into the compartment through the compartment aperture; and
wherein the reflecting mirror is located on an inner surface of the bottom wall and comprises an arcuate, light-collecting mirror extending toward the inner sidewalls.

8. The system of claim 7, further comprising:
a base of the solar energy system, the compartment being located within the base;
an upper surface of the solar energy system orientable toward sky;
a lower surface of the solar energy system opposite the upper surface; and
wherein the light-receiving aperture is defined in the upper surface and the light transmission aperture is defined in the lower surface.

9. The system of claim 8, wherein the upper and lower surfaces are located on the polyangular specular mini-structure, and wherein the polyangular, specular mini-structure is securable to the base to optically connect the light transmission aperture and the compartment aperture.

10. The system of claim 8, wherein the electrical interface is located in the base below the compartment.

11. The system of claim 1, wherein the interior reflective facets of the polyangular specular mini-structure comprise 120 triangular facets.

12. The system of claim 11, wherein the hollow chamber of the polyangular, specular mini-structure comprises one of a hollow sphere and a hollow spheroid and the interior surface of the chamber consists essentially of the 120 triangular facets and the two apertures.

13. The system of claim 12, wherein the interior reflective facets comprise a reflective layer of aluminum.

14. The system of claim 13, wherein the polyangular, specular mini-structure comprises an outer layer of PMMA, and wherein the reflective layer of aluminum comprises a second layer interior to the outer layer.

15. The system of claim 14, wherein polyangular, specular mini-structure comprise a third layer interior to the second layer and consisting essentially of silicon dioxide, wherein the three layers are concentric layers.

16. The system of claim 15, wherein the interior, reflective facets, when exposed by the light-receiving aperture to 120,000 lux, generate 170,000 lux as the light output to ex

17. The system of claim 16, further comprising a lens optically connected to the light-receiving aperture.

18. The system of claim 1, further comprising:
an array of at least eight of the polyangular, specular mini-structures arranged to define a first outer perimeter;
wherein the optical-to-electrical module is removably secured and optically connected to the at least eight polyangular specular mini-structures, the compartment of the module sized and configured to have module sidewalls defining a second outer perimeter greater than the first outer perimeter;
whereby the light responsive elements of the module are in optical communication with the light output exiting through respective ones of the transmission apertures of the polyangular, specular mini-structure.

19. A solar energy system, comprising:
a polyangular, specular, mini-structure in the form of a hollow chamber with an exterior and an interior surfaces, the interior surface having reflective facets disposed at angular orientations on the interior surface to define a light reflective interior of the chamber, the mini-structure having a light-receiving aperture and a light transmission aperture extending between the exterior and interior surfaces at respective locations on the mini-structure, each of the apertures being in optical communication with the interior of the chamber;
wherein the angularly oriented, reflective facets are located to reflect light entering through the light receiving aperture and having a first lux value sufficiently to generate a light output light having a second lux value greater than the first lux value, the light transmission aperture located and configured to permit the light output to exit therethrough;
an optical-to-electrical module secured relative to the polyangular specular mini-structure to receive the light output and convert the light output into electricity, wherein the optical-to-electrical module comprises light-responsive elements, the light responsive elements including at least one silicon surface and at least one reflecting mirror, the silicon surface and the reflecting mirror oriented to be impinged upon directly or indirectly by the light output received in optical-to-electrical module to generate an electric potential as a function of the light output; and
an electrical interface for receiving the electric potential and outputting current over time for at least one of electrical charging and storage;
wherein the light-responsive elements comprise two pairs of the silicon surfaces extending in a spaced, opposing relationship, and wherein the reflecting mirror is disposed centrally between the opposing silicon surfaces and oriented to reflect the light output toward the silicon surfaces;
wherein the optical-electrical module comprises four inner walls and wherein each of the silicon surfaces are located on respective ones of the inner walls;
wherein the hollow chamber of the polyangular, specular mini-structure comprises a hollow sphere;
wherein the interior reflective facets of the polyangular specular mini-structure comprise 120 triangular facets;
wherein the interior surface of the chamber consists essentially of the 120 triangular facets and the two apertures; and
wherein the interior reflective facets comprise a reflective layer of aluminum.

20. A method of generating solar power, the method comprising:
reflecting a received light beam having a first lux value against at least 120 specular, angular surfaces in an enclosed, palm-sized chamber to generate a light output having a second lux value greater than the first lux value;
directing the light output as a light transmission from the enclosed chamber to impinge directly and indirectly upon a reflecting mirror and at least one polysilicon, photovoltaic surface to generate an electric potential; and
outputting the electric potential as current over time to generate the solar power.
